(19) United States
(12) Patent Application Publication
(10) Pub. No.: US 2021/0117648 A1
(43) Pub. Date: Apr. 22, 2021

(54) 3-DIMENSIONAL MODEL IDENTIFICATION

(71) Applicant: Hewlett-Packard Development Company, L.P., Spring, TX (US)

(72) Inventors: Zi-Jiang Yang, Shanghai (CN); Chuang Gan, Shanghai (CN); Jili Zou, Shanghai (CN); Xi He, Shanghai (CN); Sheng Cao, Shanghai (CN); Yu Xu, Shanghai (CN)

(73) Assignee: Hewlett-Packard Development Company, L.P., Spring, TX (US)

(21) Appl. No.: 17/047,713

(22) PCT Filed: May 9, 2018
(86) PCT No.: PCT/CN2018/086117

§ 371 Date: Oct. 15, 2020

(51) Int. Cl. G06K 9/00; G06T 17/00; G06N 3/04; G06K 9/62; G06F 17/16

(52) U.S. Cl. CPC G06K 9/00208; G06T 17/00; G06F 17/16; G06K 9/6215; G06N 3/0454

(57) ABSTRACT

A method for recognizing a three-dimensional (3D) model is described. The method includes obtaining a sketch of the object and generating a skeleton view of the sketch. A first shape-description vector is determined by processing the sketch through a first convolutional neural network (CNN), and a second shape-description vector is determined by processing the skeleton view through a second CNN. A feature-description vector is identified from a descriptor database based on a concatenated vector of the first shape-description vector and the second shape-description vector. The descriptor database stores feature-description vectors obtained by training the first CNN and the second CNN over a plurality of 3D models. A 3D model of the object corresponding to the feature-description vector is identified from the plurality of 3D models.

### BACKGROUND

3-dimensional (3D) model retrieval has become popular with the advent of 3D scanning and modeling technology. 3D model retrieval may refer to identification of 3D models from a database based on inputs from a user. A user may provide an input, for example a sketch of an object, to a system which may then search for 3D models in a database and provide to the user 3D models that may closely match with the sketch. The user may utilize the 3D models for various purposes, including 3D modeling, 3D printing, etc.

### BRIEF DESCRIPTION OF THE DRAWINGS

The following detailed description references the drawings, wherein:

FIG. 1 illustrates an example block diagram of a system for identification of 3D models;

FIG. 2 illustrates an example block diagram of a system for identification of 3D models;

FIG. 3 illustrates an example method for training convolutional neural networks (CNNs) for identification of 3D models;

FIG. 4 illustrates an example method for identification of 3D models; and

FIG. 5 illustrates an example system environment implementing a non-transitory computer-readable medium for identification of 3D models.

### DETAILED DESCRIPTION

3D model retrieval may be performed through deep learning of a convolutional neural network (CNN). A CNN may refer to an artificial neural network that is used for image or object identification. A CNN may include multiple convolutional layers, pooling layers, and fully connected layers through which an image or a view of an object, in a digital format, is processed to obtain an output in the form of a multi-dimensional vector which is indicative of shape-related features of the object. Such an output of the CNN may be referred to as a feature descriptor. A feature descriptor may also be referred to as a feature-description vector or a shape-description vector. In a deep learning technique, a CNN is trained over sketch views of a set of 3D models to learn feature descriptors corresponding to the set of 3D models based on minimization of a triplet loss function. A sketch view may refer to a contour view. One feature descriptor corresponds to one 3D model. The feature descriptors learned from training the CNN are utilized for retrieving 3D models in response to a sketch of an object drawn by a user. A sketch may refer to a representation of the object, as drawn by the user.

Different users may draw a sketch of an object in various ways. Due to discrepancies between the sketch drawn by the user and the 3D models, there may be low accuracy when objects are identified using feature descriptors learned from a CNN trained over sketch views of 3D models. It is difficult to improve the accuracy of identification of 3D models by utilizing the feature descriptors learned from training a CNN over sketch views of 3D models.

The present subject matter describes approaches for retrieving or identifying 3D models from a database based on sketches drawn by a user. The approaches of the present subject matter enable identification of 3D models from a database with enhanced accuracy.

According to an example implementation of the present subject matter, two CNNs are trained over a plurality of 3D models. The plurality of 3D models, also referred to as a training data, may include 3D models of various objects and items, such as animals, vehicles, furniture, characters, CAD models, and the like. In an example implementation, a first CNN is trained to learn a feature descriptor from a plurality of 2-dimensional (2D) sketch views of each of the plurality of 3D models, and a second CNN is trained to learn a feature descriptor from a plurality of 2D skeleton views of each of the plurality of 3D models. A skeleton view may refer to a topological view, which is complementary to the contour view. The feature descriptor learned from the plurality of 2D sketch views of a 3D model may be referred to as a geometric-description vector, and the feature descriptor learned from the plurality of 2D skeleton views of the 3D model may be referred to as a topological-description vector. A geometric-description vector may be indicative of geometric shape features of a 2D sketch view, and a topological-description vector may be indicative of topological shape features of a 2D skeleton view. The two feature descriptors learned for a 3D model are concatenated to obtain a concatenated feature descriptor. The concatenated feature descriptor for each of the plurality of 3D models may be stored in a descriptor database, which may be utilized for identification of 3D models based on a sketch of an object drawn by a user.

In an example implementation, for identification of 3D models based on a sketch of an object drawn by a user, a skeleton view of the sketch is generated. The sketch is processed through the first trained CNN to determine a first shape-description vector, and the skeleton view is processed through the second trained CNN to determine a second shape-description vector. The first and second shape-description vectors are concatenated to obtain a concatenated shape-description vector. Further, the descriptor database, created during the training of the first and second CNNs, is searched to obtain feature descriptor(s) that closely match with the concatenated shape-description vector. In an example implementation, the feature descriptor(s) may be obtained from the descriptor database based on K-Nearest-Neighbor (KNN) technique. Upon obtaining the feature descriptor(s) from the descriptor database, 3D model(s) corresponding to the feature descriptor(s) are identified from the plurality of 3D models (i.e., the training data). The identified 3D model(s) are the 3D models of the object drawn by the user. The identified 3D model(s) may then be provided to the user.

Training of two CNNs, one over the sketch views of 3D models and the other over the skeleton views of the 3D models, and processing a user-drawn sketch through the two trained CNNs to identify 3D model(s), in accordance with the present subject matter, results in retrieval of 3D models with enhanced accuracy, i.e., the identified 3D model(s) closely match the object that the user has sketched.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

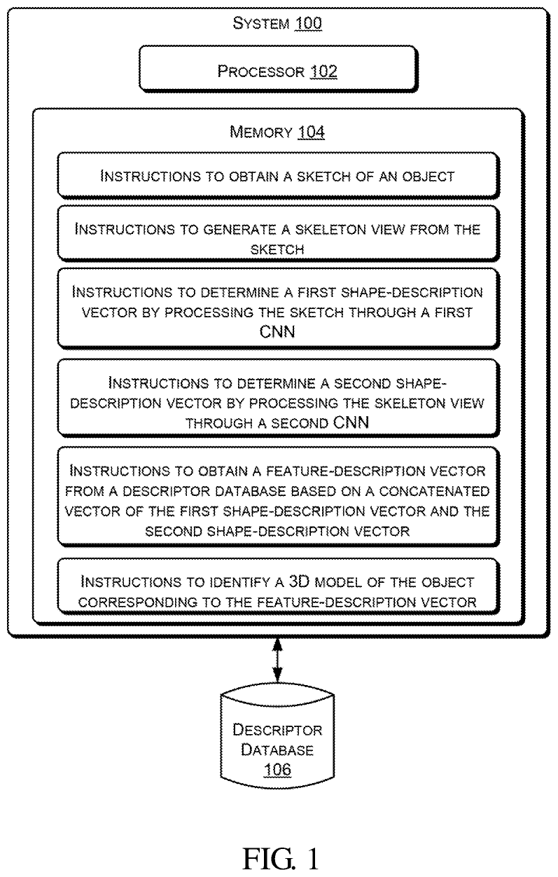

FIG. 1 illustrates an example block diagram of a system 100 for identification of 3D models. The system 100 may be implemented as a computer, for example a desktop computer, a laptop, server, and the like. The system 100 includes a processor 102 and a memory 104 coupled to the processor 102. The processor 102 may refer to as a processing resource implemented as microprocessors, microcomputers, microcontrollers, digital signal processors, central processing units, state machines, logic circuitries, and/or any devices that manipulate signals based on operational instructions. Among other capabilities, the processor 102 may fetch and execute computer-readable instructions stored in the memory 104. The memory 104 may be a non-transitory computer-readable storage medium. The memory 104 may include, for example, volatile memory (e.g., RAM), and/or non-volatile memory (e.g., EPROM, flash memory, NVRAM, memristor, etc.).

In an example implementation, the memory 104 stores instructions executable by the processor 102 to obtain a sketch of an object and generate a skeleton view from the sketch. The sketch of the object may be a hand-drawn sketch provided by a user. The memory 104 stores instructions executable by the processor 102 to determine a first shape-description vector by processing the sketch through a first convolutional neural network (CNN), and determine a second shape-description vector by processing the skeleton view through a second CNN.

The memory 104 also stores instructions executable by the processor 102 to concatenate the first shape-description vector and the second shape-description vector, and obtain a feature-description vector from a descriptor database 106 based on the concatenated vector. The system 100 may be coupled to the descriptor database 106 through a communication link to query the descriptor database 106. The communication link may be a wireless or a wired communication link. The descriptor database 106 is created during training of the first CNN and the second CNN over a plurality of 3D models, as described later in the description. The descriptor database 106 stores feature-description vectors obtained by training the first CNN and the second CNN over a plurality of 3D models. The feature-description vector which closely matches with the concatenated vector of the first shape-description vector and the second shape-description vector is obtained. In an example implementation, the feature-description vector may be obtained from the descriptor database 106 based on K-Nearest-Neighbor (KNN) technique. It may be noted that although the descriptor database 106 is shown to be external to the system 100; however, in an example implementation, the descriptor database 106 may reside in the memory 104 of the system 100.

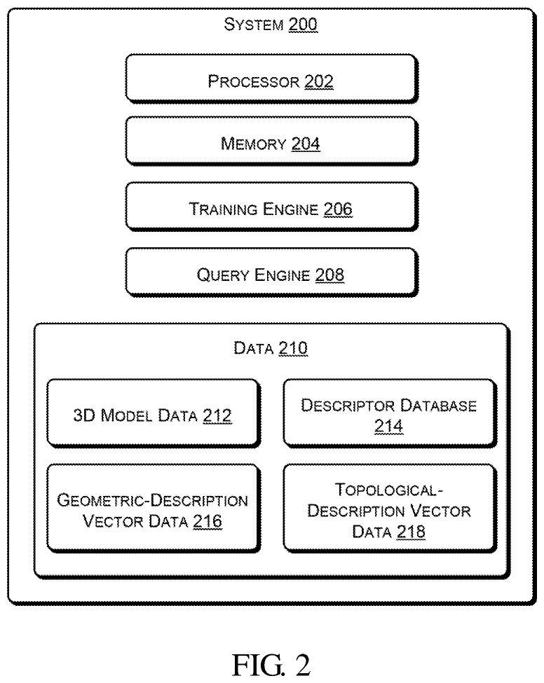

The memory 104 further stores instructions executable by the processor 102 to identify a 3D model of the object, from the plurality of 3D models, corresponding to the feature-description vector obtained from descriptor database. The identified 3D model is a 3D model of an object that may closely match with the sketch drawn by the user. The identified 3D model may then be provided to the user. Aspects described above with respect to FIG. 1 for identifying a 3D model are further described in detail with respect to FIG. 2.

For the purpose of training the first CNN and the second CNN over a plurality of the 3D models, the memory 104 stores instructions executable by the processor 102 to process each of the plurality of 3D models through the first CNN and the second CNN. For training the first and second CNNs, the memory 104 stores instructions executable by the processor to, for each of the plurality of 3D models, generate a plurality of 2D sketch views of a respective 3D model, and accordingly generate a plurality of 2D skeleton views from the plurality of 2D sketch views. The memory 104 also stores instructions executable by the processor 102 to determine a geometric-description vector by training the first CNN over the plurality of 2D sketch views based on minimization of a first triplet loss function, and determine a topological-description vector by training the second CNN over the plurality of 2D skeleton views based on minimization of a second triplet loss function.

The memory 104 further stores instructions executable by the processor to obtain a feature-description vector by concatenating the geometric-description vector and the topological-description vector, and store the feature-description vector in the descriptor database 106. Aspects described above with respect to FIG. 1 for training the first CNN and the second CNN and creating the descriptor database 106 are further described in detail with respect to FIG. 2.

FIG. 2 illustrates an example block diagram of a system 200 for identification of 3D models. The system 200 may be implemented as a computer, for example a desktop computer, a laptop, server, and the like. The system 200 includes a processor 202, similar to the processor 102 of the system 100, and includes a memory 204, similar to the memory 104 of the system 100. Further, as shown in FIG. 2, the system 200 includes a training engine 206 and a query engine 208. The training engine 206 and the query engine 208 may collectively be referred to as engine(s) which can be implemented through a combination of any suitable hardware and computer-readable instructions. The engine(s) may be implemented in a number of different ways to perform various functions for the purposes of training CNNs and identifying 3D models by processing through the trained CNNs. For example, the computer-readable instructions for the engine(s) may be processor-executable instructions stored in a non-transitory computer-readable storage medium, and the hardware for the engine(s) may include a processing resource to execute such instructions. In some examples, the memory 204 may store instructions which, when executed by the processor 202, implement the training engine 206 and the query engine 208. Although, the memory 204 is shown to reside in the system 200; however, in an example, the memory 204 storing the instructions may be external, but accessible to the processor 202 of the system 200. In another example, the engine(s) may be implemented by electronic circuitry.

Further, as shown in FIG. 2, the system 200 includes data 210. The data 210, amongst other things, serves as a repository for storing data that may be fetched, processed, received, or generated by the training engine 206 and the query engine 208. The data 210 includes 3D model data 212, descriptor database 214, geometric-description vector data 216, and topological-description vector data 218. In an example implementation, the data 210 may reside in the memory 204. Further, in some examples, the data 210 may be stored in an external database, but accessible to the processor 202 of the system 200.

The description hereinafter describes an example procedure of training two CNNs, one over sketch views of a plurality of 3D models and another over skeleton views of the plurality of 3D models, and then identifying 3D model(s) based on a sketch drawn by a user by processing the sketch through the two trained CNNs. The plurality of 3D models may be stored in the 3D model data 212. The plurality of 3D models may include 3D models of various objects and items, such as animals, vehicles, furniture, characters, CAD models, and the like. In an example implementation, two CNNs may be trained serially over the plurality of 3D models. The description herein described the procedure of training two CNNs over one 3D model. The same procedure may be repeated to train the two CNNs over the other of the plurality of 3D models in a similar manner.

For the purpose of training of CNNs over a 3D model, the training engine 206 generates a plurality of 2D sketch views of the 3D model. The training engine 206 may generate the plurality of 2D sketch views based on a skeleton length of the 2D sketch view. In an example, the training engine 206 may generate 2D sketch views from N viewpoints (e.g., N=72). A 2D sketch view of a 3D model from one viewpoint may refer to a 2D perspective view of the 3D model when viewed from one direction. The training engine 206 may then compute a skeleton length of each of the 72 2D sketch views, and sort the 72 2D sketch views in decreasing order of skeleton lengths. The training engine 206 may then select M number of 2D sketch views, having top M longest skeleton lengths, as the plurality of 2D sketch views for the purpose of training the CNNs. In an example, M may be equal to 8. In an example implementation, values of N and M may be defined by a user.

In an example implementation, the training engine 206 may process each of the plurality of 2D sketch views to remove small length curves and big curvature curves and apply local and global deformations to enhance relevancy factor of the 2D sketch view for training the CNNs.

After generating the plurality of 2D sketch views, the training engine 206 generates a plurality of 2D skeleton views from the plurality of 2D sketch views. In an example, the training engine 206 may process each of the plurality of 2D sketch views based on a thinning algorithm and a pruning algorithm to generate a respective 2D skeleton view.

Further, the training engine 206 determines a geometric-description vector (GDV) by training a first CNN over the plurality of 2D sketch views based on minimization of a first triplet loss function. In an example implementation, the first CNN involves multiple convolutional layers and four fully connected layers, each with a rectifier unit (ReLU), as listed in Table 1. Table 1 also enlists filter size, stride, filter number, and padding size used for the first CNN. Each of the layers numbered 1, 2, 3, and 4 is followed by max pooling with a filter size 3×3 and a stride of 2. The layer numbered 5 is followed by average pooling with a filter size 3×3 and a stride of 3. Each 2D sketch view may be inputted as 700×700×1 tensor.

TABLE 1

| Layer | | Filter | Filter | | Padding | |
|---|---|---|---|---|---|---|
| Number | Type | Size | Number | Stride | Size | Output Size |
| 1 | Convolution | 9 × 9 | 64 | 3 | 0 | 231 × 231 × 64 |
| 2 | Convolution | 5 × 5 | 128 | 1 | 0 | 111 × 111 × 128 |
| 3 | Convolution | 3 × 3 | 256 | 1 | 1 | 55 × 55 × 256 |
| 4 | Convolution | 3 × 3 | 256 | 1 | 1 | 27 × 27 × 256 |
| 5 | Convolution | 3 × 3 | 512 | 1 | 1 | 13 × 13 × 512 |
| 6 | Fully | — | — | 1 | 0 | 1024 |
| | Connected | | | | | |
| | (Dropout of | | | | | |
| | 0.7) | | | | | |
| 7 | Fully | — | — | 1 | 0 | 512 |
| | Connected | | | | | |
| | (Dropout of | | | | | |
| | 0.7) | | | | | |
| 8 | Fully | — | — | 1 | 0 | 128 |
| | Connected | | | | | |
| | (Dropout of | | | | | |
| | 0.7) | | | | | |
| 9 | Fully | — | — | 1 | 0 | 16 |
| | Connected | | | | | |

Further, the first triplet loss function involves a set of triplets, each triplet having an anchor sample, a positive sample, and a negative sample corresponding to the 3D model for which the first CNN is trained. The triplet loss function for each triplet is defined as max(Pdist−Ndist+α, 0), where Pdist is Euclid distance between a feature-description vector of the anchor sample and a feature-description vector of the positive sample, Ndist is Euclid distance between a feature-description vector of the anchor sample and a feature-description vector of the negative sample, and a is training engine 206 margin which may be set to 0.6. The GDV determined from the first CNN is a 16-dimensional vector. The GDV may be stored in the geometric-description vector data 216.

The training engine 206 also determines a topological-description vector (TDV) by training a second CNN over the plurality of 2D skeleton views based on minimization of a second triplet loss function. The second CNN and the second triplet loss function may be similar to the first CNN and the first triplet loss function, respectively. The TDV determined from the second CNN is also a 16-dimensional vector. The TDV may be stored in the topological-description vector data 218.

After determining the GDV and the TDV, the training engine 206 obtains a feature-description vector (FDV) by concatenating the GDV and the TDV. Thus, the (FDV)=(GDV, TDV), which is a 32-dimensional vector. The training engine 206 then stores the FDV in the descriptor database 214.

The procedure described above for obtaining the FDV for one 3D model is repeated to obtain or learn FDVs for the other of the plurality of 3D models in a similar manner. The FDVs for the plurality of 3D models are stored in the descriptor database 214.

After storing the FDVs obtained by training the first and second CNNs over the plurality of 3D models, the query engine 208 obtains a hand-drawn sketch of an object for which 3D model(s) are to be retrieved or identified. A user may draw the sketch using an input device (not shown), such as a mouse, a touch-based input device, or the like. The input device may be coupled to the system 200 for the user to draw a sketch.

After obtaining the sketch of the object, the query engine 208 generates a skeleton view from the sketch. In an example, the query engine 208 may process the sketch based on a thinning algorithm and a pruning algorithm to generate the skeleton view of the object.

After generating the skeleton view, the query engine 208 determines a first shape-description vector (SDV1) by processing the sketch of the object through the first CNN trained by the training engine 206, and determines a second shape-description vector (SDV2) by processing the skeleton view of the object through the second CNN trained by the training engine 206. Each of the SDV1 and the SDV2 is a 16-dimensional vector, similar to the GDV or the TDV obtained during training of the first and second CNNs.

After determining the SDV1 and the SDV2, the query engine 208 obtains a concatenated vector (cSDV) by concatenating the SDV1 and the SDV2. Thus, the (cSDV)=(SDV1, SDV2), which is a 32-dimensional vector.

After obtaining the cSDV, the query engine 208 obtains an FDV from the descriptor database 214 based on Euclid distance D between the cSDV and each of the FDVs stored in the descriptor database 214. In an example implementation, Euclid distance D between a cSDV and an FDV is equal to as shown below in equation (1):

[symbol]

(1)

wherein:

$$\tilde{{d}_{i}} = \frac{{d}_{i}}{λ + {d}_{i}} , i ∈ \{ 1 , 2 \} ; \qquad ( 2 )$$

d₁ is Euclid distance between the SDV1 of the cSDV and the GDV of the FDV;

d₂ is Euclid distance between the SDV2 of the cSDV and the TDV of the FDV; and

λ is ≥1 and ≤5.

Here, λ is a parameter which restricts the value of [symbol] ≥0 and <1, and alleviates the domination of [symbol] over [symbol] , and vice versa.

The query engine 208 may obtain that FDV from the descriptor database 214 for which the Euclid distance with respect to the cSDV is minimum. After obtaining the FDV, the query engine 208 identifies a 3D model corresponding to the obtained FDV from the 3D model data 212. The query engine 208 may then provide to the user the identified 3D model as a prospective 3D model corresponding to the sketch of the object drawn by the user.

In an example implementation, the query engine 208 may obtain top P number of FDVs from the descriptor database 214 for which the Euclid distance with respect to the cSDV is minimum. In an example, P may be equal to 5. After obtaining the P number of FDVs, the query engine 208 may identify P number of 3D models corresponding to the obtained P number of FDV from the 3D model data 212. The query engine 208 may then provide to the user the identified P number of 3D models as prospective 3D models corresponding to the sketch of the object drawn by the user. In an example implementation, value of P may be defined by a user.

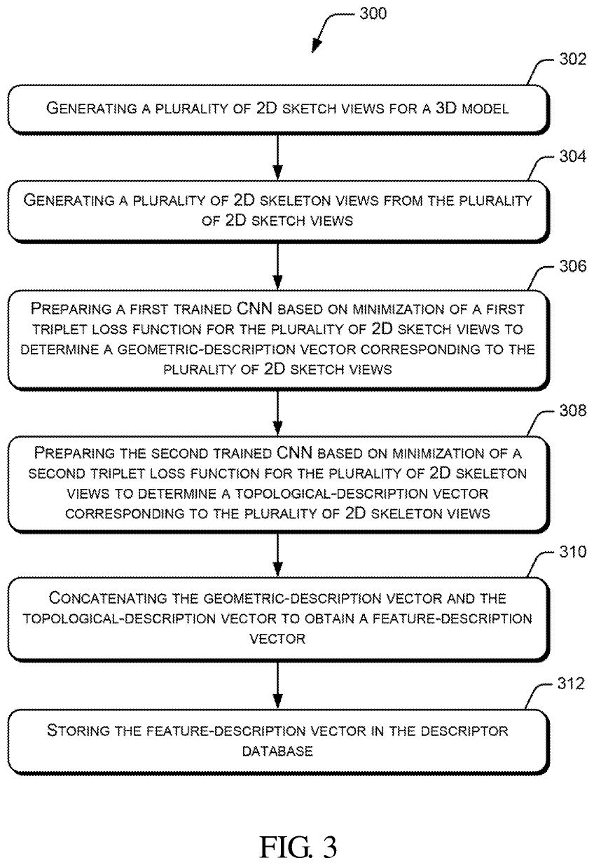

FIG. 3 illustrates an example method 300 for training CNNs for identification of 3D models. The method 300 can be implemented by a processing resource or a system through any suitable hardware, a non-transitory machine-readable medium, or a combination thereof. In some example implementations, processes involved in the method 300 can be executed by a processing resource, for example the processor 102 or 202 based on instructions stored in a non-transitory computer-readable medium, for example the memory 104 or 204. The non-transitory computer-readable medium may include, for example, digital memories, magnetic storage media, such as a magnetic disks and magnetic tapes, hard drives, or optically readable digital data storage media.

The method 300 described herein is for training two CNNs over one 3D model. The same procedure, in accordance with the method 300, may be repeated to train the two CNNs over the other of the plurality of 3D models in a similar manner.

Referring to FIG. 3, at block 302, a plurality of 2D sketch views is generated for a 3D model, and at block 304, a plurality of 2D skeleton views is generated from the plurality of 2D sketch views. In an example implementation, the plurality of 2D sketch views may be generated based on a skeletal length of 2D sketch view. Example procedures of generating the plurality of 2D sketch views and the plurality of 2D skeleton views by the processor 102 or 202 are described earlier in the description.

At block 306, a first trained CNN is prepared based on minimization of a first triplet loss function for the plurality of 2D sketch views to determine a geometric-description vector (GDV) corresponding to the plurality of 2D sketch views. Similarly, at block 308, a second trained CNN is prepared based on minimization of a second triplet loss function for the plurality of 2D skeleton views to determine a topological-description vector (TDV) corresponding to the plurality of 2D skeleton view.

Further, at block 310, the GDV and the TDV are concatenated to obtain a feature-description vector (FDV). At block 312, the FDV is stored in a descriptor database, for example the descriptor database 106 or 214.

The method 300 described above is repeated to obtain or learn FDVs for the other of the plurality of 3D models in a similar manner. The FDVs for the plurality of 3D models are stored in the descriptor database.

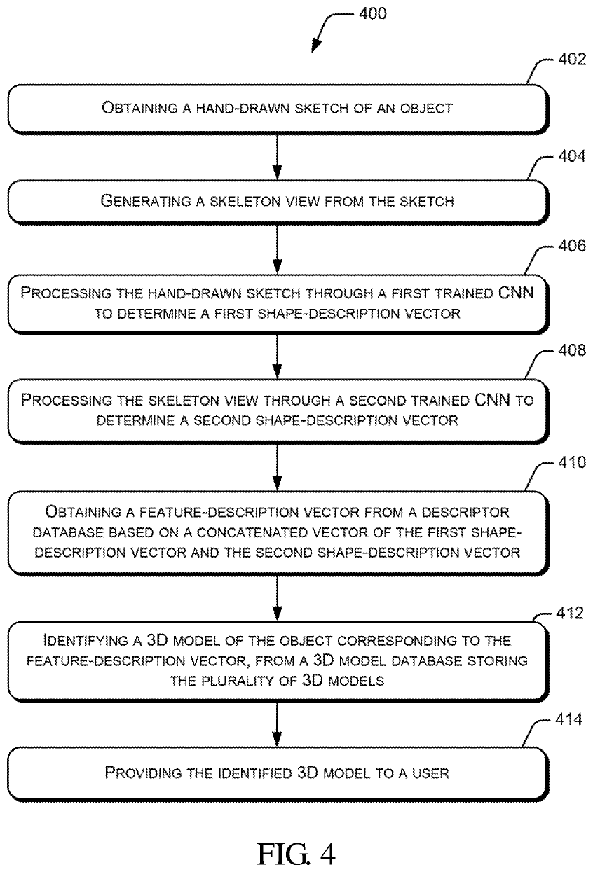

FIG. 4 illustrates an example method 400 for identification of 3D models. The method 400 can be implemented by a processing resource or a system through any suitable hardware, a non-transitory machine-readable medium, or a combination thereof. In some example implementations, processes involved in the method 400 can be executed by a processing resource, for example the processor 102 or 202 based on instructions stored in a non-transitory computer-readable medium, for example the memory 104 or 204. The non-transitory computer-readable medium may include, for example, digital memories, magnetic storage media, such as a magnetic disks and magnetic tapes, hard drives, or optically readable digital data storage media.

Referring to FIG. 4, at block 402, a hand-drawn sketch of an object is obtained. The hand-drawn sketch may be obtained by a processing resource from an input device, such as a mouse, a touch-based input device, or the like, accessible to a user for drawing the sketch. At block 404, a skeleton view is generated from the sketch. The skeleton view may be generated by the processing resource in a manner as described earlier in the description.

At block 406, the hand-drawn sketch is processed through the first trained CNN to determine a first shape-description vector (SDV1), and at block 408, the skeleton view is processed through the second trained CNN to determine a second shape-description vector (SDV2). At block 410, an FDV is obtained from the descriptor database based on a concatenated vector (cSDV) of the SDV1 and the SDV2. In an example implementation, the FDV may be obtained from the descriptor database based on Euclid distance D between the cSDV and each of the FDVs stored in the descriptor database. The details of Euclid distance D between a cSDV and an FDV are described earlier in the description through equation (1).

After obtaining the FDV from the descriptor database, a 3D model of the object corresponding to the FDV is identified from a 3D model database storing the plurality of 3D models, at block 412. The 3D model database may be the 3D model data 212 stored in the system 200. At block 414, the identified 3D model is provided to a user.

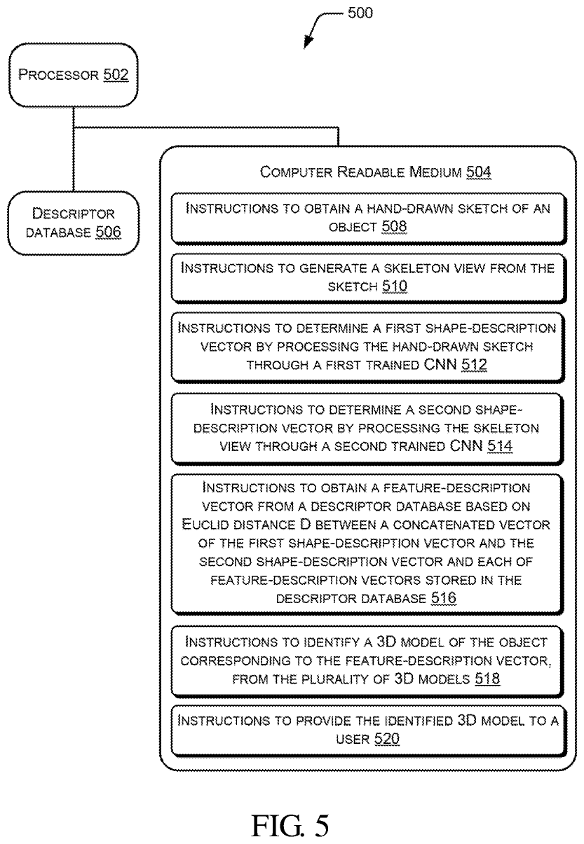

FIG. 5 illustrates an example system environment 500 implementing a non-transitory computer-readable medium for identification of 3D models. The system environment 500 includes a processor 502 communicatively coupled to the non-transitory computer-readable medium 504. In an example, the processor 502 may be a processing resource of a system for fetching and executing computer-readable instructions from the non-transitory computer-readable medium 504. The system may be the system 100 or 200 as described with reference to FIGS. 1 and 2.

The non-transitory computer-readable medium 504 can be, for example, an internal memory device or an external memory device. In an example implementation, the processor 502 may be communicatively coupled to the non-transitory computer-readable medium 504 through a communication link. The communication link may be a direct communication link, such as any memory read/write interface. In another example implementation, the communication link may be an indirect communication link, such as a network interface. In such a case, the processor 502 can access the non-transitory computer-readable medium 504 through a communication network.

In an example implementation, the non-transitory computer-readable medium 504 includes a set of computer-readable instructions for training of CNNs and for identification of 3D models through the trained CNNs. The set of computer-readable instructions can be accessed by the processor 502 and subsequently executed to perform acts for training of CNNs and for identification of 3D models through the trained CNNs. The processor 502 is communicatively coupled to a descriptor database 506. The processor 502 may access the descriptor database 506 for storing feature-description vectors obtained from training of two CNNs and also obtaining feature-description vectors for identification of 3D model(s) based on a sketch drawn by a user.

Referring to FIG. 5, in an example, the non-transitory computer-readable medium 504 includes instructions 508 to obtain a hand-drawn sketch of an object. The hand-drawn sketch of the object may be obtained from an input device coupled to the processor 502. The non-transitory computer-readable medium 504 includes instructions 510 to generate a skeleton view from the sketch. The non-transitory computer-readable medium 504 further includes instructions 512 to determine a first shape-description vector (SDV1) by processing the hand-drawn sketch through a first trained CNN, and instructions 514 to determine a second shape-description vector (SDV2) by processing the skeleton view through a second trained CNN.

The non-transitory computer-readable medium 504 includes instructions 516 to obtain a feature-description vector (FDV) from the descriptor database 506 based on Euclid distance D between a concatenated vector (cSDV) of the SDV1 and the SDV2 and each of feature-description vectors (FDVs) stored in the descriptor database 506. The details of Euclid distance D between a cSDV and an FDV are described earlier in the description through equation (1). The FDVs, stored in the descriptor database 506, are obtained from preparation of the first trained CNN and the second trained CNN over a plurality of 3D models, as described herein.

The non-transitory computer-readable medium 504 includes instructions 518 to identify a 3D model of the object corresponding to the FDV, from the plurality of 3D models, and includes instructions 520 to provide the identified 3D model to the user.

In an example implementation, for preparing the first and second trained CNNs over the plurality of 3D models, the non-transitory computer-readable medium 504 includes instructions to, for each 3D model: generate a plurality of 2D sketch views for each of the plurality of 3D models; generate a plurality of 2D skeleton views from the plurality of 2D sketch views; prepare the first trained CNN based on minimization of a first triplet loss function for the plurality of 2D sketch views to determine a geometric-description vector (GDV) corresponding to the plurality of 2D sketch views; prepare the second trained CNN based on minimization of a second triplet loss function for the plurality of 2D skeleton views to determine a topological-description vector (TDV) corresponding to the plurality of 2D skeleton views; concatenate the GDV and the TDV to obtain a feature-description vector (FDV); and store the FDV in the descriptor database 506.

Although examples for the present disclosure have been described in language specific to structural features and/or methods, it is to be understood that the appended claims are not limited to the specific features or methods described herein. Rather, the specific features and methods are disclosed and explained as examples of the present disclosure.

What is claimed is:

1. A system comprising:
a processor; and
a memory coupled to the processor, the memory storing instructions executable by the processor to:
obtain a sketch of an object;
generate a skeleton view from the sketch;
determine a first shape-description vector by processing the sketch through a first convolutional neural network (CNN);
determine a second shape-description vector by processing the skeleton view through a second CNN;
obtain a feature-description vector from a descriptor database based on a concatenated vector of the first shape-description vector and the second shape-description vector, wherein the descriptor database stores feature-description vectors obtained by training the first CNN and the second CNN over a plurality of 3-dimensional (3D) models; and
identify a 3D model of the object, from the plurality of 3D models, corresponding to the feature-description vector.

2. The system as claimed in claim 1, wherein the memory stores instructions executable by the processor to, for each of the plurality of 3D models:
generate a plurality of 2-dimensional (2D) sketch views of a respective 3D model to train the first CNN and the second CNN;
generate a plurality of 2D skeleton views from the plurality of 2D sketch views;
determine a geometric-description vector by training the first CNN over the plurality of 2D sketch views based on minimization of a first triplet loss function;
determine a topological-description vector by training the second CNN over the plurality of 2D skeleton views based on minimization of a second triplet loss function;
obtain a feature-description vector by concatenating the geometric-description vector and the topological-description vector; and
store the feature-description vector in the descriptor database.

3. The system as claimed in claim 2, wherein the memory stores instructions executable by the processor to generate the plurality of 2D sketch views based on a skeletal length of 2D sketch view.

4. The system as claimed in claim 1, wherein the memory stores instructions executable by the processor to obtain the feature-description vector from the descriptor database based on Euclid distance D between the concatenated vector and each of the feature-description vectors stored in the descriptor database.

5. The system as claimed in claim 4, wherein Euclid distance D between the concatenated vector and a feature-description vector is equal to [symbol]
,
wherein:
$$\tilde{{d}_{i}} = \frac{{d}_{i}}{λ + {d}_{i}} , i ∈ \{ 1 , 2 \} ;$$
d₁ is Euclid distance between the first shape-description vector of the concatenated vector and a geometric-description vector of the feature-description vector;
d₂ is Euclid distance between the second shape-description vector of the concatenated vector and a topological-description vector of the feature-description vector; and
λ is ≥1 and ≤5.

6. The system as claimed in claim 1, wherein the sketch is a hand-drawn sketch.

7. A method comprising:
obtaining, by a processing resource, a hand-drawn sketch of an object;
generating, by the processing resource, a skeleton view from the sketch;
processing, by the processing resource, the hand-drawn sketch through a first trained convolutional neural network (CNN) to determine a first shape-description vector;
processing, by the processing resource, the skeleton view through a second trained CNN to determine a second shape-description vector;
obtaining, by the processing resource, a feature-description vector from a descriptor database based on a concatenated vector of the first shape-description vector and the second shape-description vector, wherein the descriptor database stores feature-description vectors obtained from preparation of the first trained CNN and the second trained CNN over a plurality of 3-dimensional (3D) models;
identifying, by the processing resource, a 3D model of the object corresponding to the feature-description vector, from a 3D model database storing the plurality of 3D models; and
providing the identified 3D model to a user.

8. The method as claimed in claim 7, wherein the method further comprises, for each of the plurality of 3D models:
generating, by the processing resource, a plurality of 2-dimensional (2D) sketch views for a respective 3D model;
generating, by the processing resource, a plurality of 2D skeleton views from the plurality of 2D sketch views;
preparing, by the processing resource, the first trained CNN based on minimization of a first triplet loss function for the plurality of 2D sketch views to determine a geometric-description vector corresponding to the plurality of 2D sketch views;
preparing, by the processing resource, the second trained CNN based on minimization of a second triplet loss function for the plurality of 2D skeleton views to determine a topological-description vector corresponding to the plurality of 2D skeleton views;
concatenating the geometric-description vector and the topological-description vector to obtain a feature-description vector; and
storing the feature-description vector in the descriptor database.

9. The method as claimed in claim 8, wherein generating the plurality of 2D sketch views is based on a skeletal length of 2D sketch view.

10. The method as claimed in claim 7, wherein obtaining the feature-description vector from the descriptor database is based on Euclid distance D between the concatenated vector and each of the feature-description vectors stored in the descriptor database.

11. The method as claimed in claim 10, wherein Euclid distance D between the concatenated vector and a feature-description vector is equal to [symbol]
,
wherein:
$$\tilde{{d}_{i}} = \frac{{d}_{i}}{λ + {d}_{i}} , i ∈ \{ 1 , 2 \} ;$$
d₁ is Euclid distance between the first shape-description vector of the concatenated vector and a geometric-description vector of the feature-description vector;
d₂ is Euclid distance between the second shape-description vector of the concatenated vector and a topological-description vector of the feature-description vector; and
λ is ≥1 and ≤5.

12. A non-transitory computer-readable medium comprising computer-readable instructions, which, when executed by a processor, cause the processor to:
obtain a hand-drawn sketch of an object;
generate a skeleton view from the sketch;
determine a first shape-description vector by processing the hand-drawn sketch through a first trained convolutional neural network (CNN);
determine a second shape-description vector by processing the skeleton view through a second trained CNN;
obtain a feature-description vector from a descriptor database based on Euclid distance D between a concatenated vector of the first shape-description vector and the second shape-description vector and each of feature-description vectors stored in the descriptor database, wherein the feature-description vectors are obtained from preparation of the first trained CNN and the second trained CNN over a plurality of 3-dimensional (3D) models;
identify a 3D model of the object corresponding to the feature-description vector, from the plurality of 3D models; and
provide the identified 3D model to a user.

13. The non-transitory computer-readable medium as claimed in claim 12, wherein the instructions which, when executed by the processor, cause the processor to:
generate a plurality of 2-dimensional (2D) sketch views for a respective 3D model;
generate a plurality of 2D skeleton views from the plurality of 2D sketch views;
prepare the first trained CNN based on minimization of a first triplet loss function for the plurality of 2D sketch views to determine a geometric-description vector corresponding to the plurality of 2D sketch views;
prepare the second trained CNN based on minimization of a second triplet loss function for the plurality of 2D skeleton views to determine a topological-description vector corresponding to the plurality of 2D skeleton views;
concatenate the geometric-description vector and the topological-description vector to obtain a feature-description vector; and
store the feature-description vector in the descriptor database.

14. The non-transitory computer-readable medium as claimed in claim 13, wherein the plurality of 2D sketch views is generated based on a skeletal length of 2D sketch view.

15. The non-transitory computer-readable medium as claimed in claim 12, wherein Euclid distance D between the concatenated vector and a feature-description vector is equal to [symbol]
,
wherein:
$$\tilde{{d}_{i}} = \frac{{d}_{i}}{λ + {d}_{i}} , i ∈ \{ 1 , 2 \} ;$$
d₁ is Euclid distance between the first shape-description vector of the concatenated vector and a geometric-description vector of the feature-description vector;
d₂ is Euclid distance between the second shape-description vector of the concatenated vector and a topological-description vector of the feature-description vector; and
λ is ≥1 and ≤5.
